(19) United States
(12) Patent Application Publication
(10) Pub. No.: US 2012/0163505 A1
(43) Pub. Date: Jun. 28, 2012

(54) METHOD AND APPARATUS OF SIGNAL DETECTION IN WIRELESS LOCAL AREA NETWORK SYSTEM

(75) Inventors: Jung Bo SON, Daejeon-si (KR); Hun Sik KANG, Daejeon-si (KR); Sok Kyu LEE, Daejeon-si (KR)

(73) Assignee: Electronics and Telecommunications Research Institute, Daejeon-si (KR)

(21) Appl. No.: 13/333,691

(22) Filed: Dec. 21, 2011

(30) Foreign Application Priority Data
Dec. 23, 2010 (KR) 10-2010-0133436

(51) Int. Cl. H04L 27/22

(52) U.S. Cl. 375/329

(57) ABSTRACT

Disclosed is a method and receiver for detecting a wireless signal in a wireless local area network (WLAN) system. The receiver includes a radio frequency (RF) unit which receives a wireless signal; an analog/digital converter (ADC) which converts the wireless signal into a digital signal; a fast Fourier transform (FFT) unit which applies FFT to the digital signal; a multiple inputs and multiple outputs (MIMO) detector which performs channel compensation for the FFT applying result; a constellation-demapping unit which constellation-demaps with regard to the channel compensation result; a decoder which decodes the constellation-demapping result; and a high throughput (HT) detector which determines whether the wireless signal is a signal modulated with quadrature binary phase shift keying (Q-BPSK) constellation obtained by rotating binary phase shift keying (BPSK) constellation at an angle of 90 degrees on the basis of the FFT applying result.

### CROSS-REFERENCE TO RELATED APPLICATIONS

This application claims the benefit of priority of Korean Patent Application No. 10-2010-0133436 filed on Dec. 23, 2010, all of which are incorporated by reference in their entirety herein.

### BACKGROUND OF THE INVENTION

1. Field of the invention

The present invention provides wireless communications, and more particularly, to a method and apparatus for signal detection based on autocorrelation in a wireless local area network (WLAN) system.

2. Related Art

With recent development of information and communication technology, various wireless communication technologies have been developed. Among them, a wireless local area network (WLAN) based on wireless frequency technology allows a portable terminal such as a personal digital assistant (PDA), a laptop computer, a portable multimedia player (PMP), etc. to wirelessly access Internet in a home, an office or a certain service proving region.

Since institute of electrical and electronics engineers (IEEE) 802 standards for the WLAN technology was established in February 1980, a lot of standardization has been achieved.

In an early stage of the WLAN technology, IEEE 802.11 has supported a speed of 1-2 Mbps using a frequency of 2.4 GHz through frequency hopping, spread spectrum, infrared communication, etc. Recently, orthogonal frequency division multiplex (OFDM) has been applied to support the maximum speed of 54 Mbps. Besides, IEEE 802.11 is in commercialization or development of various standards for technology such as enhancement of quality for service (QoS), protocol compatibility of an access point, security enhancement, radio source measurement, wireless access vehicular environment, fast roaming, mesh network, wireless network management, etc.

Further, there is IEEE 802.11n as technology standards relatively recently established to surpass the limit of communication speed, which has been pointed out as a weak point in the WLAN. IEEE 802.11n is intended for increasing the speed and reliability of a network, and expanding an operating distance in a wireless network. More specifically, IEEE 802.11n is based on multiple inputs and multiple outputs (MIMO) technology that supports a high throughput (HT), in which the maximum speed of the data processing is equal to or higher than 540 Mbps, and uses multiple antennas at both a transmitter and a receiver to minimize a transmission error and optimize a data speed. Also, this standard may employ not only a coding method of transmitting many duplicated copies to increase data reliability, but also orthogonal frequency division multiplex (OFDM) to increase the speed.

The IEEE 802.11n high throughput (HT) WLAN system has introduced not only a physical layer convergence procedure (PLCP) format supporting a legacy station (STA), but also an HT green field PLCP format designed to be efficient for the HT STA, which can be used in a system including only the HT STAs supporting the IEEE 802.11n. Also, The IEEE 802.11n high throughput (HT) WLAN system supports an HT mixed PLCP format designed to support an HT system in a system where the legacy STA and the HT STA coexist.

In an HT mixed PLCP frame, an HT-SIG field is mapped for modulation after experiencing encoding and interleaving, in which a quadrature binary phase shift keying (QBPSK) constellation is employed. The QBPSK constellation is obtained by rotating a BPSK constellation at an angle of 90 degrees. Since an L-SIG field uses a general BPSK constellation, it is convenient to detect the HT-SIG field.

More details of the HT green field PLCP format and the HT mixed PLCP format may be referred to “IEEE P802.11n™/D11.0, Draft STANDARD for Information Technology-Telecommunications and information exchange between systems-Local and metropolitan area networks-Specific requirements Part 11: Wireless LAN Medium Access Control (MAC) and Physical Layer (PHY) specifications Amendment 5: Enhancements for Higher Throughput, Clause 20. High Throughput PHY specification” disclosed in June 2009.

When the HT STA detects the HT-SIG field of the HT mixed PLCP frame, two additional operations are possible besides a mode of normally reading and operating the HT-SIG field. The HT STA may operate in a legacy mode as the HT-SIG field is unrecognized, or notifies a cyclic redundancy checking (CRC) error through PHY-RXEDN.indication (Format Violation) instead of PHY-RXSTART.indication as an error is detected as a result of performing CRC even though the HT-SIG field is recognized. At this time, the HT PHY first keeps PHY-CCA. indication (BUSY, channel list) until a received level is lowered below a certain CCA sensitivity level (e.g., an energy detection threshold) indicating an idle channel.

To make the STA normally operate in the IEEE 802.11n WLAN system, there is a need for weighing a method for more effectively and correctly detecting the HT-SIG field and reducing total packet errors that occurs due to an HT mode detection error.

### SUMMARY OF THE INVENTION

The present invention provides a method and apparatus for signal detection based on autocorrelation, in which an HT-SIG field signal is more effectively and correctly detected in an IEEE 802.11n WLAN system, so that total packet errors that occurs due to an HT mode detection error can be reduced and efficiency of wireless resources can be improved.

In an aspect, a method for detecting a signal in a wireless local area network (WLAN) system includes: receiving and converting a wireless signal into a digital signal; applying fast Fourier transform (FFT) to the digital signal; performing channel compensation for the FFT applying result; constellation-demapping with regard to the channel compensation result; and decoding the constellation-demapping result, the FFT applying result being employed for determining whether the wireless signal is a signal modulated with quadrature binary phase shift keying (Q-BPSK) constellation obtained by rotating binary phase shift keying (BPSK) constellation at an angle of 90 degrees.

The determining whether the wireless signal is a signal modulated with the Q-BPSK constellation obtained by rotating the BPSK constellation at an angle of 90 degrees may be based on autocorrelation between the FFT applying result of a legacy (L)-SIG signal transmitted just before the wireless signal and the FFT applying result of the wireless signal.

The L-SIG signal may be transmitted as being modulated with the BPSK constellation.

The determining whether the wireless signal is a signal modulated with the Q-BPSK constellation obtained by rotating the BPSK constellation at an angle of 90 degrees may include storing the FFT applying result of an legacy (L)-SIG signal transmitted just before the wireless signal; and obtaining autocorrelation between a value Y_{L} in a predetermined subcarrier of the L-SIG signal and a value Y_{HT} in a predetermined subcarrier of the wireless signal.

The autocorrelation between the Y_{L} and the Y_{HT} may be calculated as follows:

y_{L}*·y_{HT}=(hx_{L}+n_{L})*·(hx_{HT}+n_{HT})=∥h∥² x_{L}*x_{HT}+h*x_{L}*n_{HT}+hx_{HT}x_{L}*+n_{L}*n_{HT}

where, h is a channel matrix, x_{L} is data in the predetermined subcarrier of the L-SIG signal, n_{L} is noise in the predetermined subcarrier of the L-SIG signal, x_{HT} is data in the predetermined subcarrier of the wireless signal, and n_{HT} is noise in the predetermined subcarrier of the wireless signal.

The L-SIG signal may be transmitted as being modulated with the BPSK constellation.

In another aspect, the receiver includes: a radio frequency (RF) unit which receives a wireless signal; an analog/digital converter (ADC) which converts the wireless signal into a digital signal; a fast Fourier transform (FFT) unit which applies FFT to the digital signal; a multiple inputs and multiple outputs (MIMO) detector which performs channel compensation for the FFT applying result; a constellation-demapping unit which constellation-demaps with regard to the channel compensation result; a decoder which decodes the constellation-demapping result; and a high throughput (HT) detector which determines whether the wireless signal is a signal modulated with quadrature binary phase shift keying (Q-BPSK) constellation obtained by rotating binary phase shift keying (BPSK) constellation at an angle of 90 degrees on the basis of the FFT applying result.

The receiver may further include a first buffer which operates in a front end of the FFT unit and increases an operating clock speed; and a second buffer which operates in a back end of the FFT unit and decreases the operating clock speed.

The HT detector may determine whether the wireless signal is a signal modulated with the Q-BPSK constellation obtained by rotating the BPSK constellation at an angle of 90 degrees on the basis of autocorrelation between the FFT applying result of a legacy (L)-SIG signal transmitted just before the wireless signal and the FFT applying result of the wireless signal.

The L-SIG signal may be transmitted as being modulated with the BPSK constellation.

The HT detector may include a memory which stores the FFT applying result of an legacy (L)-SIG signal transmitted just before the wireless signal; an ABS unit which obtains absolute values of a real number part and an imaginary number part with regard to a value Y_{L} in a predetermined subcarrier of the L-SIG signal and a value Y_{HT} in a predetermined subcarrier of the wireless signal, respectively; and an ACC unit which accumulates the absolute values.

The size of the memory may be determined by the number of predetermined subcarriers.

In light of HT-SIG detection in the IEEE 802.11n WLAN system, phase rotation can be ascertained with regard to more subcarriers as compared with that in a method for signal detection based on I/Q energy comparison after the existing MIMO detector (or equalizer), so that the accuracy of the HT-signal detection can be improved. Further, weight about the channel information is applied, so that corresponding performance enhancement can be expected.

### BRIEF DESCRIPTION OF THE DRAWINGS

FIG. 1 illustrates PHY layer architecture of IEEE 802.11.

FIG. 2 is a block diagram illustrating an example of a HT mixed PLCP frame format in a WLAN system where an L-STA and an HT-STA coexist.

FIG. 3 shows control information included in an HT-SIG field.

FIG. 4 illustrates BPSK and Q-BPSK constellations used in mapping an L-SIG field and an HT-SIG field, respectively.

FIG. 5 is a block diagram showing an exemplary configuration of a receiver that performs HT mode detection by comparing an I-phase and a Q-phase.

FIG. 6 is a block diagram showing a structure of the receiver having a buffer, to which an exemplary embodiment of the present invention can be applied.

FIG. 7 is a timing diagram of each unit of the receiver having the structure of FIG. 6.

FIG. 8 illustrates subcarriers that can be used for detecting an HT-SIG detection.

FIG. 9 is a block diagram showing a receiver according to an exemplary embodiment of the present invention.

FIG. 10 illustrates an example of an HT-SIG detection block according to an exemplary embodiment of the present invention.

### DESCRIPTION OF EXEMPLARY EMBODIMENTS

Below, an exemplary embodiment of the present invention will be described in detail with reference to accompanying drawings.

A wireless local area network (WLAN) system, in which an exemplary embodiment of the present invention is realized, includes at least one basic service set (BSS). The BSS is a set of stations (STA) successfully synchronized for communicating with each other. The BSS can be classified into an independent BSS (IBSS) and an infrastructure BSS.

The BSS includes at least one STA and an access point (SP). The AP is a functional medium providing connection to each STA in the BSS through a wireless medium. The AP may be alternatively called a centralized controller, a base station (BS), a scheduler, etc.

The STA is a discretionary functional medium including medium access control (MAC) and wireless-medium physical layer (PHY) interfaces which satisfies the IEEE 802.11 standards. The STA may be an AP or a non-AP STA, but refers to the non-AP STA as long as it is not separately mentioned. The STA may be alternatively called a user equipment (UE), a mobile station (MS), a mobile terminal (MT), a portable device, an interface card, etc.

The STA may be divided into a high throughput (HT)-STA and a legacy (L)-STA. The HT-STA refers to an STA supporting the IEEE 802.11n, and the L-STA refers to an STA supporting a low version of the IEEE 802.11n, e.g., IEEE 802.11a/g. The L-STA may also be called a non-HT STA.

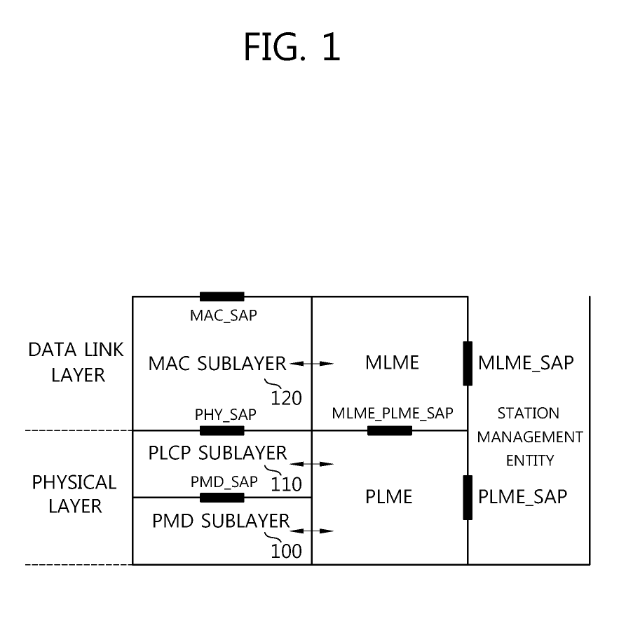

FIG. 1 illustrates PHY layer architecture of IEEE 802.11.

The PHY layer architecture of the IEEE 802.11 includes a PHY layer management entity (PLME), a physical layer convergence procedure (PLCP) sub-layer 110, and a physical medium dependent (PMD) sub-layer 100. The PLME provides a management function for the PHY layer in cooperation with a MAC layer management entity (MLME). The PLCP sub-layer 110 is provided between the MAC sub-layer 120 and the PMD sub-layer 100, and transmits a MAC protocol data unit (MPDU) from the MAC sub-layer 120 to the PMD sub layer 100 or transmits a frame from the PMD sub-layer 100 to the MAC sub layer 120 in accordance with instruction of the MAC sub-layer 120. The PMD sub-layer 100 is a low layer of the PLCP, and allows the physical layer entity to be transmitted and received between two stations via a wireless medium.

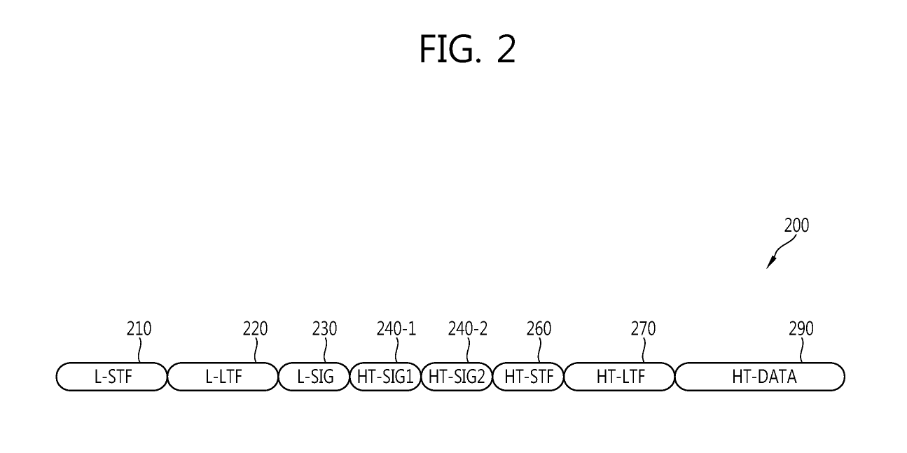

The PLCP sub-layer 110 adds an additional field including information needed by a PHY layer transceiver while receiving the MPDU from the MAC sub-layer 120 and transmitting it to the PMD sub-layer 100. At this time, the additional field added to the MPDU may include a PLCP preamble, a PLCP header, a tail bits needed on a data field, etc. The PLCP preamble serves to make the receiver prepare synchronization function and antenna diversity before transmitting PLCP service data unit (PSDU=MPDU). The PLCP header includes a field having information about the frame, which will be described in more detail with reference to FIG. 2.

The PLCP sub-layer 110 generates a PLCP protocol data unit (PPDU) by adding the above field to the MPDU, and transmits it to a receiving station via the PMD sub-layer. The receiving station receives the PPDU and obtains information needed for restoring data from the PLCP preamble and the PLCP header, thereby restoring the data.

FIG. 2 is a block diagram illustrating an example of a HT mixed PLCP frame format in a WLAN system where an L-STA and an HT-STA coexist.

The HT mixed PLCP frame may include an L-STF 210, an L-LTF 220, an L-SIG field 230, an HT-SIG field, an HT-STF 260, an HT-LTF 270 and an HT-DATA field 290. The HT-SIG field is divided into two parts, i.e., an HT-SIG1 240-1 and an HT-SIG2 240-2. Each of the HT-SIG1 240-1 and the HT-SIG2 240-2 may include 24 bits.

The PLCP sub-layer adds necessary information to the MPDU received from the MAC layer, converts it to data 290 of FIG. 2, and adds the L-STF 210, the L-LTF 220, the L-SIG field 230, the HT-SIG field, the HT-STF 260, the HT-LTF 270, or the like field to generate the PPDU frame 200, thereby transmitting it to one or more STAs via the PMD layer.

The L-STF 210 is used in frame timing acquisition, automatic gain control, coarse frequency acquisition, etc.

The L-LTF 220 is used in estimating a channel for demodulating the L-SIG field 230 and the HT-SIG field 240.

The HT-STF 260 is transmitted for enhancing AGC estimation in the MIMO system. The duration of the HT-STF 260 is 4 μs.

The HT-LTF 270 is provided in plural and used in estimating a channel for demodulating the data field 290.

A short training field (STF) such as the L-STF 210 and the HT-STF 260 is used for the frame timing acquisition, the automatic gain control, etc., so that it can be called a synchronous signal or a synchronous channel. That is, the STF is used for synchronization between the STAs or between the STA and the AP.

A long training field (LTF) such as the L-LTF 220 and the HT-LTF 270 is used in estimating a channel for demodulating data and/or control information, so that it can be called a reference signal, a training signal or a pilot.

The L-SIG field 230 and the HT-SIG field 240-1, 240-2 provide various information needed for demodulating and decoding data, so that is can be called control information.

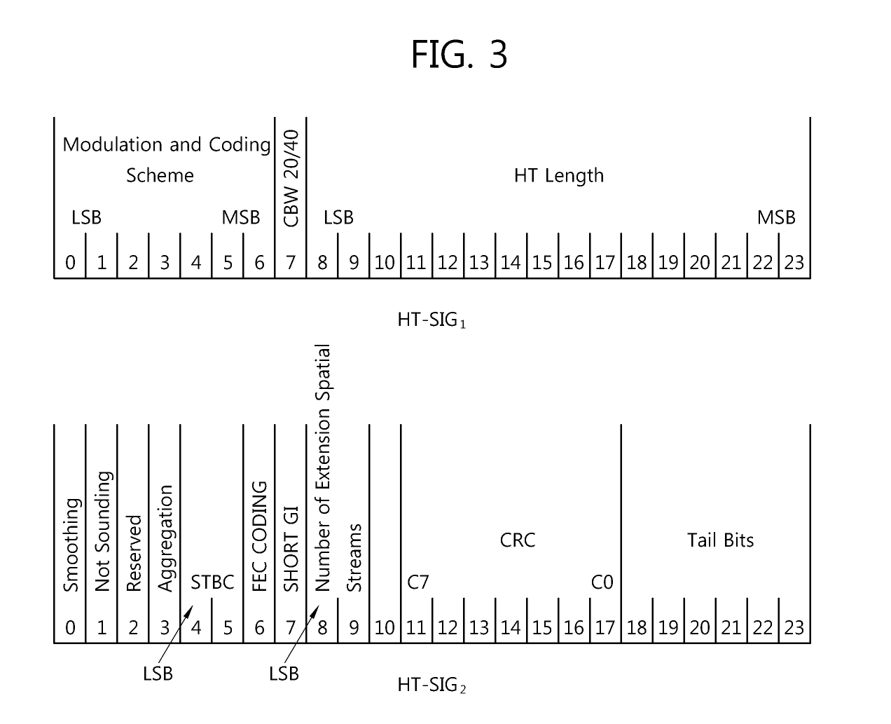

FIG. 3 shows control information included in the HT-SIG field 240-1, 240-2.

More details of the role and function of each control information may refer to “IEEE P802.11n™/D11.0, Draft STANDARD for Information Technology-Telecommunications and information exchange between systems-Local and metropolitan area networks-Specific requirements Part 11: Wireless LAN Medium Access Control (MAC) and Physical Layer (PHY) specifications Amendment 5: Enhancements for Higher Throughput, Clause 20. High Throughput PHY specification” disclosed in June 2009.

As shown in the format of the HT mixed mode PLCP frame, to maintain compatibility with the existing legacy WLAN system, the same frame format as the legacy WLAN system is maintained before the HT-SIG field.

The HT-SIG field is divided into an HT-SIG1 and an HT-SIG2, which is encoded at a coding rate R=1/2 and mapped by the BPSK constellation. Also, the HT-SIG field includes a plurality of pilots. The constellation used in mapping the HT-SIG field 240-1, 240-2 is the Q-BPSK constellation obtained by shifting the phase of the BPSK constellation used for mapping the L-SIG field by an angle of 90 degrees so that the receiving STA can easily detect a start of the HT-SIG field.

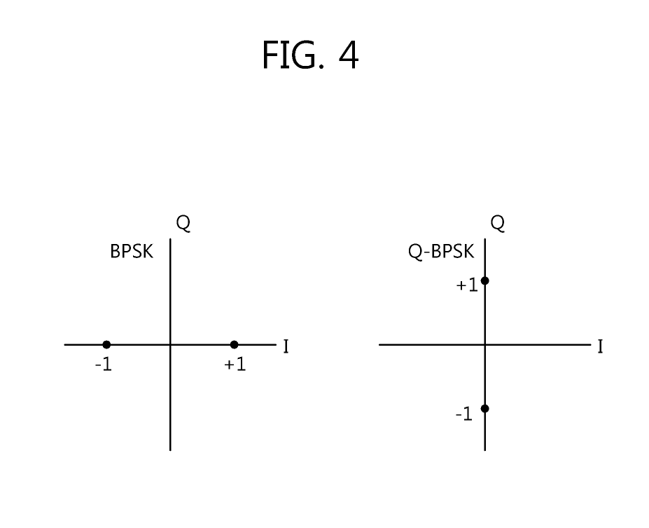

FIG. 4 illustrates BPSK and Q-BPSK constellations used in mapping an L-SIG field and an HT-SIG field, respectively.

The receiving STA, which performs the mapping by shifting the constellation applied to the HT-SIG and receives the PPDU, applies a fast Fourier transform (FFT) to the received OFDM signal and compares energy of an I-phase component with energy of a Q-phase component when the value of the HT-SIG field enters in the state that compensation for the channel is completed, thereby recognizing the HT-SIG field and detects an HT mode if the energy of the Q-phase component is greater than the energy of the I-phase component.

Then, the HT-SIG signal is restored in accordance with Q-BPSK modulation, and the following signal is restored in the form of the HT-frame format. If the detection of the HT-SIG field is failed, in other words, if the determination of the HT-SIG field using comparison between the Q-phase component and the I-phase component is not correct, an error checking process based on the CRC results in fail, so that the whole corresponding received packet may be lost. Accordingly, the whole HT signal detection and the throughput of the whole system may be affected by the accuracy of the HT-SIG field detection.

However, in the case of a system using a general operating clock of 40 MHz and applying an FFT of 128 points to a bandwidth of 40 MHz, time given to detect the HT-SIG field with regard to continuous input data is nothing but several clock cycles. That is, this time does not have to exceed a guard interval (GI) as a characteristic of an OFDM signal. In addition, if time taken in channel compensation is included, the number of subcarriers to be used for detecting the HT-SIG is further decreased.

As a method for solving such a problem, there may be considered a method of securing enough time taken in detecting the HT-SIG by increasing an operating clock speed of the whole system. However, a problem arises in that the clocks of the whole system cannot be indefinitely increased due to complexity of the system, difficult realization, etc. Also, if a block that performs operation related to compensation for the channel includes multi-antennas, it may be more difficult to increase the clock speed than other blocks due to the complexity of the system.

As described above, in order to detect the Q-BPSK signal in the HT-SIG field, the I-phase and the Q-phase have been conventionally compared with respect to an energy level when the HT-SIG field value is input in the state that the compensation for the channel is completed after applying the FFT to the received OFDM signal. Then, when the Q-phase signal is just great, the HT mode detection was achieved on the basis of this information.

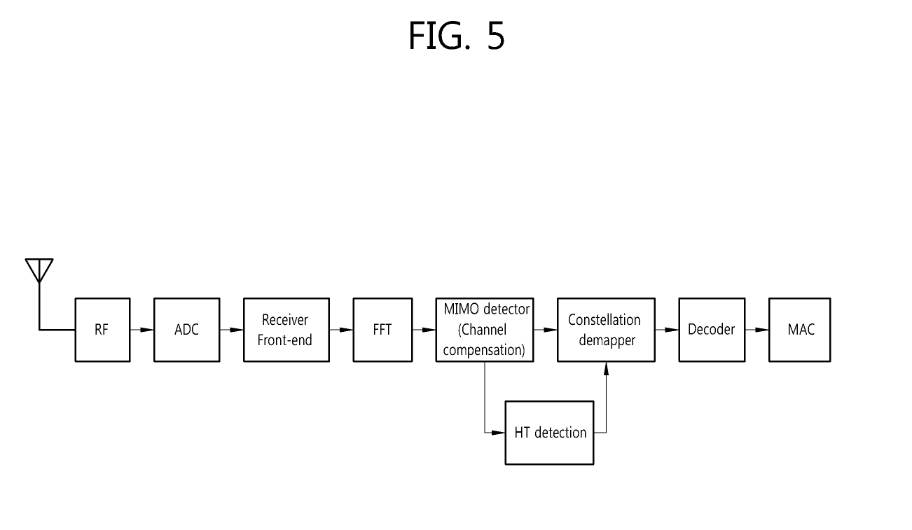

FIG. 5 is a block diagram showing an exemplary configuration of a receiver that performs the HT mode detection by comparing the I-phase and the Q-phase.

In a receiving terminal as shown in FIG. 5, to process the continuously and successively input data, it may be designed that a plurality of FFT units for performing the FFT is used for continuous operation or otherwise the operating clock speed is more than doubled, after a receiver front-end operating in a time domain.

Below, the receiving terminal will be described on the assumption that the FFT clock speed is doubled after the receiver front-end.

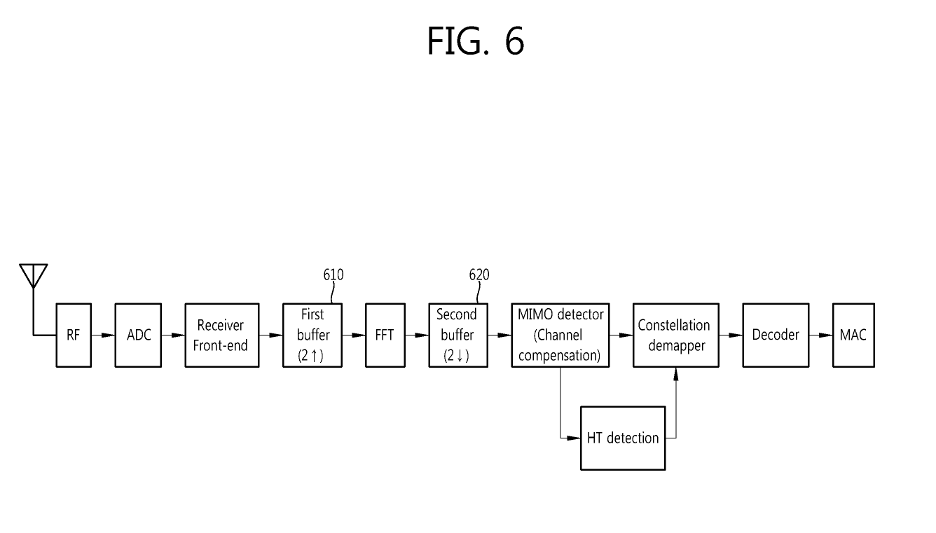

FIG. 6 is a block diagram showing a structure of the receiver having a buffer, to which an exemplary embodiment of the present invention can be applied.

Referring to the structure of the receiving terminal shown in FIG. 6, a first buffer 610 is provided in an FFT input terminal, and a second buffer 620 is provided for decreasing the operating clock speed for operation of an MIMO detector susceptible to timing after the FFT.

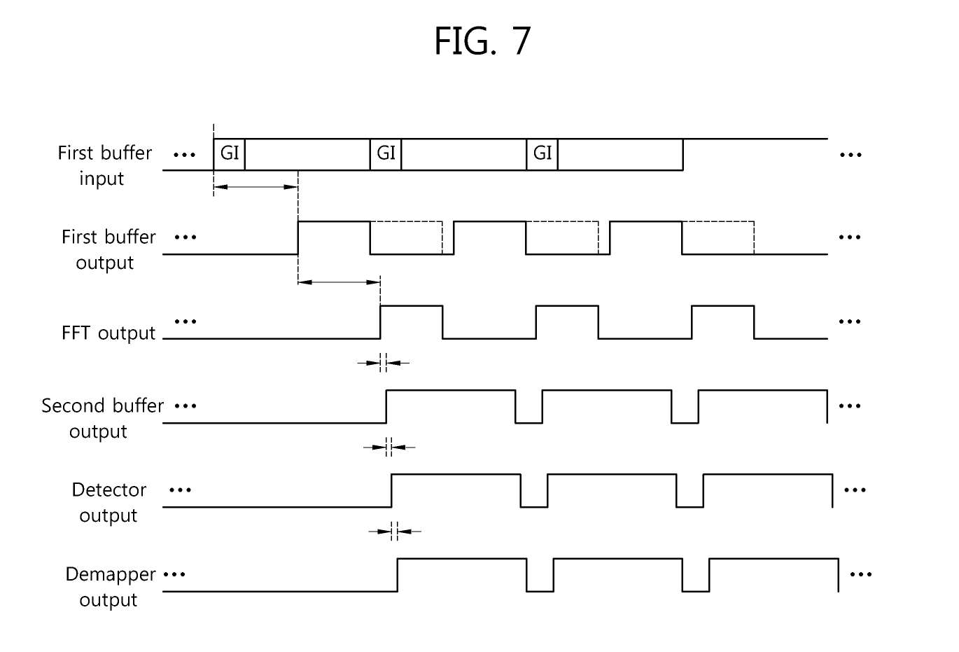

FIG. 7 is a timing diagram of each unit of the receiver having the structure of FIG. 6.

If the output of the detector is used for the HT-SIG detection, due to the continuously output data, the number of subcarriers used for detecting the HT-SIG in practice is possible in a section except a delay section used for the HT-SIG detection and the detector in a GI section.

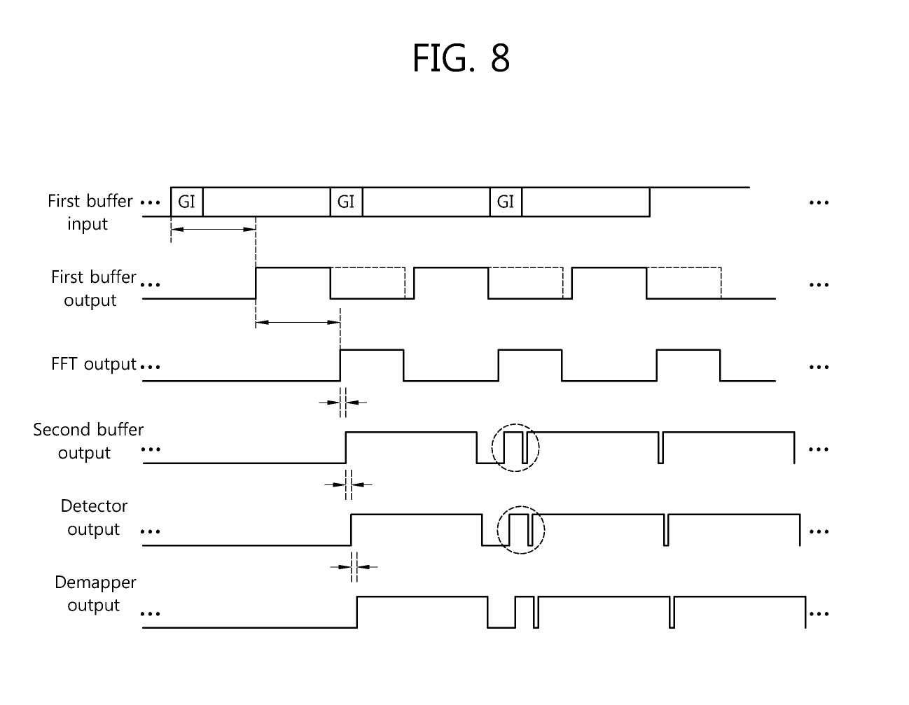

FIG. 8 illustrates subcarriers that can be used for detecting an HT-SIG detection.

The HT-SIG detection is achieved by energy comparison between the I-phase component and the Q-phase component with regard to only the subcarriers during a very short section within the dotted Circle of FIG. 8

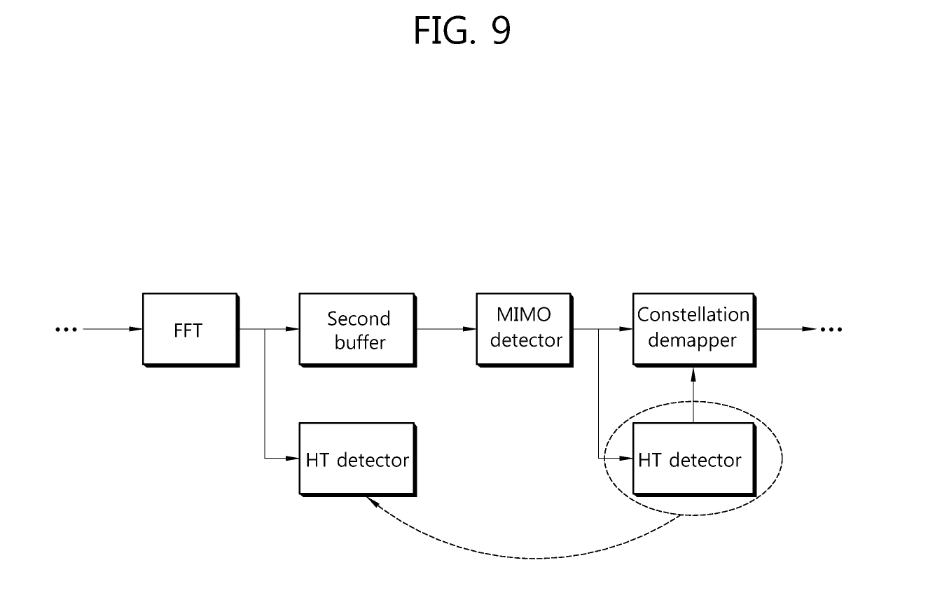

FIG. 9 is a block diagram showing a receiver according to an exemplary embodiment of the present invention.

To increase probability of the HT-SIG detection while solving the foregoing problem, the receiver in this exemplary embodiment of the present invention performs the HT-SIG detection in an FFT output terminal.

As above, to perform the HT-SIG detection in the FFT output terminal, a phase shift in a part of the HT-SIG field has to be detected, which can be determined on the basis of autocorrelation between the L-SIG field and the HT-SIG field.

That is, the expansions of the L-SIG and the HT-SIG in a frequency domain with respect to one subcarrier are as shown in the following equation 1.

y₁=hx₁+n₁(L-SIG)

y₂=hx₂+n₂(HT-SIG) [Equation 1]

where, y₁ and y₂ are L-SIG and HT-SIG signals received in the receiving terminal, x₁ and x₂ are signals transmitted in the transmitting terminal, h is a channel matrix, and n₁ and n₂ represent white Gaussian noise (AWGN).

In the WLAN system, because the channel is assumed to be quasi-static during one packet section, the channel matrix h is not changed but only the transmitted signals x₁ and x₂ are changed with regard to one subcarrier. Thus, the correlation between y₁ and y₂ received by x₁ having the I-phase information and x₁ having the Q-phase information is as shown in the following equation 2.

y₁*·y₂=(hx₁+n₁)*·(hx₂+n₂)=∥h∥₂x₁*x₂+h*x₁*n₂+hx₂x₁*+n₁*n₂) [Equation 2]

To obtain an expectation of the above correlation, the term of the signal multiplied by the AWGN in the right side of the equation 2 may approximate to 0, and it is thus neglectable. Further, x₁*x₂is an imaginary value, and thus the rotation of the HT-SIG can be ascertained.

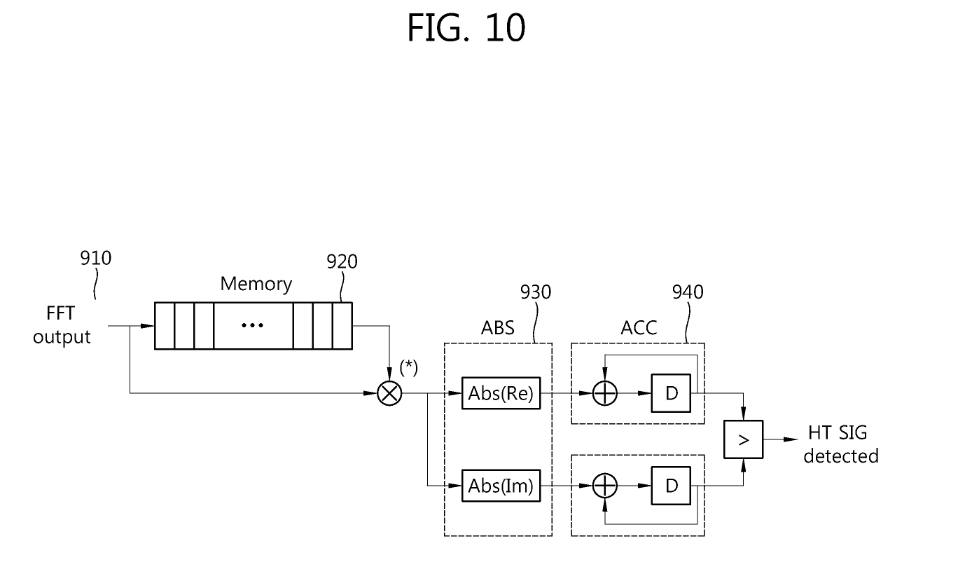

FIG. 10 illustrates an example of an HT-SIG detection block according to an exemplary embodiment of the present invention.

While the FTT output 910 of the L-SIG field is implemented, the memory 920 stores it. At this time, the size of the memory 920 may be defined as many as the number of operation results of the autocorrelation to be used for detecting the HT-SIG. Further, when the FFT output of the HT-SIG field is implemented, an operation for obtaining the autocorrelation and a value in the same subcarrier stored in the memory 920. Then, an ABS unit 930 obtains an absolute value of a real number part and an absolute value of an imaginary number part from the operation result, and the absolute value of the real number part and the absolute value of the imaginary number part are accumulated in an ACC unit 940.

When there is no more data for obtaining the correlation, the accumulated absolute value of the real number part and the accumulated absolute value of the imaginary number part are compared with each other. If the absolute value of the imaginary number part is larger than that of the real number part, a signal of the HT-SIG detection is generated, thereby informing a demapping block that the HT-SIG signal is detected.

As above, in the case where the correlation is obtained in the FFT output terminal, the rotation of the HT-SIG can be ascertained with respect to more than doubled subcarrier data as compared with the HT-SIG field detection based on output of a conventional MIMO detector, so that detecting performance can be more improved than that of a conventional case.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method for detecting a signal in a wireless local area network (WLAN) system, the method comprising:
receiving and converting a wireless signal into a digital signal;
applying fast Fourier transform (FFT) to the digital signal;
performing channel compensation for the FFT applying result;
constellation-demapping with regard to the channel compensation result; and
decoding the constellation-demapping result,
wherein the FFT applying result being employed for determining whether the wireless signal is a signal modulated with quadrature binary phase shift keying (Q-BPSK) constellation obtained by rotating binary phase shift keying (BPSK) constellation at an angle of 90 degrees.

2. The method of claim 1, wherein the determining whether the wireless signal is a signal modulated with the Q-BPSK constellation obtained by rotating the BPSK constellation at an angle of 90 degrees is based on autocorrelation between the FFT applying result of a legacy (L)-SIG signal transmitted just before the wireless signal and the FFT applying result of the wireless signal.

3. The method of claim 2, wherein the L-SIG signal is transmitted as being modulated with the BPSK constellation.

4. The method of claim 1, wherein the determining whether the wireless signal is a signal modulated with the Q-BPSK constellation obtained by rotating the BPSK constellation at an angle of 90 degrees comprises
storing the FFT applying result of an legacy (L)-SIG signal transmitted just before the wireless signal; and
obtaining autocorrelation between a value Y_{L} in a predetermined subcarrier of the L-SIG signal and a value Y_{HT} in a predetermined subcarrier of the wireless signal.

5. The method of claim 4, wherein the autocorrelation between the Y_{L} and the Y_{HT} is calculated as follows:
y_{L}*·y_{HT}=(hx_{L}+n_{L})*·(hx_{HT}+n_{HT})=∥h∥² x_{L}*x_{HT}+h*x_{L}*n_{HT}+hx_{HT}x_{L}*+n_{L}*n_{HT}
where, h is a channel matrix, x_{L} is data in the predetermined subcarrier of the L-SIG signal, n_{L} is noise in the predetermined subcarrier of the L-SIG signal, x_{HT} is data in the predetermined subcarrier of the wireless signal, and n_{HT} is noise in the predetermined subcarrier of the wireless signal.

6. The method of claim 4, wherein the L-SIG signal is transmitted as being modulated with the BPSK constellation.

7. A receiver comprising:
a radio frequency (RF) unit which receives a wireless signal;
an analog/digital converter (ADC) which converts the wireless signal into a digital signal;
a fast Fourier transform (FFT) unit which applies FFT to the digital signal;
a multiple inputs and multiple outputs (MIMO) detector which performs channel compensation for the FFT applying result;
a constellation-demapping unit which constellation-demaps with regard to the channel compensation result;
a decoder which decodes the constellation-demapping result; and
a high throughput (HT) detector which determines whether the wireless signal is a signal modulated with quadrature binary phase shift keying (Q-BPSK) constellation obtained by rotating binary phase shift keying (BPSK) constellation at an angle of 90 degrees on the basis of the FFT applying result.

8. The receiver of claim 7, further comprising
a first buffer which operates in a front end of the FFT unit and increases an operating clock speed; and
a second buffer which operates in a back end of the FFT unit and decreases the operating clock speed.

9. The receiver of claim 7, wherein the HT detector determines whether the wireless signal is a signal modulated with the Q-BPSK constellation obtained by rotating the BPSK constellation at an angle of 90 degrees on the basis of autocorrelation between the FFT applying result of a legacy (L)-SIG signal transmitted just before the wireless signal and the FFT applying result of the wireless signal.

10. The receiver of claim 9, wherein the L-SIG signal is transmitted as being modulated with the BPSK constellation.

11. The receiver of claim 8, wherein the HT detector comprises
a memory which stores the FFT applying result of an legacy (L)-SIG signal transmitted just before the wireless signal;
an ABS unit which obtains absolute values of a real number part and an imaginary number part with regard to a value Y_{L} in a predetermined subcarrier of the L-SIG signal and a value Y_{HT} in a predetermined subcarrier of the wireless signal, respectively; and
an ACC unit which accumulates the absolute values.

12. The receiver of claim 11, wherein the size of the memory is determined by the number of predetermined subcarriers.
